(19) United States
(12) Patent Application Publication
(10) Pub. No.: US 2008/0191376 A1
(43) Pub. Date: Aug. 14, 2008

(54) Solution Casting Method

(75) Inventors: Jiro Higuchi, Kanagawa (JP); Morito Kato, Kanagawa (JP); Yuji Suzuki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku, Tokyo (JP)

(21) Appl. No.: 11/885,835

(22) PCT Filed: Mar. 2, 2006
(86) PCT No.: PCT/JP06/04535

§ 371 Date: Sep. 7, 2007

(30) Foreign Application Priority Data
Mar. 7, 2005 (JP) 2005-062811

(51) Int. Cl. B29C 41/26

(52) U.S. Cl. 264/101

(57) ABSTRACT

A dope including a polymer and a solvent is discharged from a casting die (30) to a casting drum (31) while forming a casting bead (38). An upstream side (38a) area of the casting bead (38) is decompressed by a decompression chamber (36) to (atmospheric pressure—300)Pa. Air shielding plates (70, 71) are provided inside the decompression chamber (36). Openings (90) are respectively formed in upper half portions of the air shielding plates (70, 71). A distance L (mm) between a contact position A of the casting bead (38) and the air shielding plate (70) is set in the range of 20 mm to 100 mm. After the casting bead (38) forms a casting film (39) on the casting drum (31), the casting film (39) is peeled and dried to obtain a TAC film.

### TECHNICAL FIELD

The present invention relates to a method for producing a film, more particularly, the present invention relates to the method for producing the film used as a protection film for a polarizing filter and an optical compensation film in an LCD device, or a photographic support film.

### BACKGROUND ART

A cellulose acylate film, particularly a cellulose triacetate (TAC) film produced from a TAC with average acetylation degree from 57.5% to 62.5% is used as a photographic support film for a photographic photosensitive material owing to its toughness and fire-resistant property. Further, because of its excellent optical isotropy, the TAC film is used as a protection film for a polarizing filter, an optical compensation film, for instance, a wide view film and the like in an LCD device whose market is expanding recently.

Usually, the TAC film is produced by a solution casting method. The solution casting method, compared to other film producing method such as a melt-extrusion method, enables to produce the film with superior physical properties such as optical property. In the solution casting method, a high polymer solution (hereinafter referred to as a dope) is prepared in which a polymer is dissolved in a mixed solvent containing dichloromethane or methyl acetate as a main solvent. The dope is cast from a casting die onto a support to form a casting film. Upon obtaining a self supporting property on the support, the casting film is peeled off from the support as a wet film, that is, a film containing the solvent. The wet film is dried and wound as the film (for instance, see Japan Institute of Invention and Innovation Technical Disclosure No. 2001-001745).

As a film production speed increases, an air flow generated in the proximity of the casting bead becomes a serious problem. The casting bead is the dope from the casting die to the support. The air flow is generated in the proximities of the casting film and the casting bead in accordance with the movement of the support. When the casting bead is exposed to such air flow, the thickness of the casting bead becomes uneven so that the thickness of the film also becomes uneven as a product. Further, when the air flow is blown onto the casting bead and mixed into the casting bead, the voids formed by the mixed air may be ruptured in the film in the later process and deteriorate a film surface condition. The deterioration of the film surface condition means that the film surface becomes uneven by projections and depressions formed on the film surface. To solve the above problems, the pressure in an upstream area from a casting bead surface which comes in contact with the support, that is, an upstream side of the casting bead with respect to the support moving direction is reduced to a value lower than a downstream side of the casting bead. For that reason, a decompression chamber is provided in the casting die.

Recently, attempts have been made to further increase the support moving speed to further increase the film production speed. However, since the air flow volume increases as the support moving speed increases, the unevenness in the film thickness in the support moving direction and in the width direction is more likely to occur. To prevent influence of the air flow on the casting bead, it becomes necessary to increase the decompression degree in the upstream area of the casting bead, that is, to lower the absolute pressure. However, since there is a limitation in increasing the decompression degree, the influence of the air flow cannot be completely eliminated. Thus, there has been no effective means for preventing the exposure of the casting bead to the air flow, and it has been difficult to devise a means for preventing the unevenness in the film thickness. Further, as the air flow volume increases, the air flow is more likely to enter between the casting bead and the support to cause the unevenness in the film thickness and the deterioration of the film surface.

Recently, the TAC film is used as a base film for the optical function film. In such cases, a film of, for instance, 40 μm in thickness which is thinner than the conventional film of, for instance, 80 μm is required. In producing a thinner film, the uniformity in the film thickness is further required. Accordingly, it becomes more necessary to uniformly form the casting bead compared to the conventional method.

An object of the present invention is to provide a solution casting method capable of producing the film without the unevenness in the film thickness by preventing the generation of the air flow.

### DISCLOSURE OF INVENTION

As inventors conducted an elaborated investigation, the causes of unevenness in film thickness are as follow: (1) an air flow is generated by a decompression chamber sucking air from an ambience, and the generated air flow blows onto a casting bead; and (2) the air flow blows onto a casting bead. Further, the inventors found out that the air flow enters between the support and the casting bead to cause the unevenness in the film thickness. The entrance of the air flow results from: (3) fluctuations of a contact position of the casting bead to the support caused by an air vortex generated in the decompression chamber; and (4) an increase in an elongational stress of the casting bead according to the increase of the solid concentration of the dope. Note that (3) describes a so-called floating of an active contact position. (4) is based on a recent trend that the solid concentration of the dope is likely to be increased to improve drying effect and drying efficiency during a drying process.

According to the solution casting method of the present invention, the dope including the polymer and the solvent is cast from a casting die to a moving support to form a casting film. The cast film is peeled as a film and then dried. The dope from the casting die to the support is called a casting bead. A decompression device decompresses an upstream area from the casting bead with respect to a support moving direction. Inside the decompression chamber, a plate member is disposed which extends in a width direction of the casting bead in a standing posture. A distance L (mm) between the plate member and a contact position in which the casting bead comes in contact with the support preferably satisfies 20 mm≦L (mm)≦100 mm.

An opening is preferably provided in the plate member to pass the air flow. Plural openings are preferably formed in an upper half portion of the plate member in the vertical direction. An area ratio of the openings to the area of the plate member is preferably in a range of 0.5% to 30%.

A clearance CL (mm) between the decompression chamber and the support is in a range of 0.05 mm to 3.0 mm. The pressure inside the decompression device is preferably in a range of (atmospheric pressure—2000)Pa to (atmospheric pressure—10)Pa. Further, a moving speed of the support is in a range of 30 m/min to 150 m/min.

According to the solution casting method of the present invention, the dope including the polymer and the solvent is cast from the casting die to the moving support to form the casting film, and the casting film is peeled from the support and dried to form the film. In this solution casting method, the upstream area from the casting bead is decompressed by the decompression chamber having the plate member extending in the width direction of the support. Accordingly, the air flow is prevented from blowing onto the casting bead so that the changes in the thickness of the casting bead are prevented. Since the casting bead forms the casting film on the support, the unevenness in the film thickness is prevented.

According to the solution casting film of the present invention, when the distance between the contact position in which the casting bead comes in contact with the support and the plate member is defined as L (mm), L (mm) satisfies 20 mm≦L (mm)≦100 mm. Further, since the opening for discharging the air flow away from the casting bead is formed in the plate member, the casting bead is prevented from being exposed to the air flow. Further, the air flow in the decompression chamber is controlled through the opening of the plate member. Thereby, the air flow from the upstream side from the casting bead is extremely weakened and is prevented from blowing onto the casting bead. Note that when the plural openings are formed in the upper half portion of the plate member in the vertical direction, the air flow control is more facilitated.

The air flow from the upstream from the casting bead in the support moving direction is effectively prevented by providing plural number of the plate members, for instance, in a range of two to eleven in the upstream with respect to the support moving direction.

The present invention is more effective in producing a thin film (thickness of approximately 40 μm) than a thick film (thickness of approximately 80 μm). Further, the formation of the casting bead is more stabilized by preventing the air flow from blowing onto the casting bead, and thus the troubles in the production are drastically decreased. Further, when the cellulose acylate is used as the polymer, a thin film with an excellent optical isotropy is produced which is preferably used as the optical function film.

### BRIEF DESCRIPTION OF DRAWINGS

FIG. 1 is a schematic view illustrating a film production line of the solution casting method of the present invention;

FIG. 2 is a schematic section view of a decompression chamber;

FIG. 3 is a schematic section view of the decompression chamber used in the solution casting method of the present invention; and

FIG. 4 is a schematic view illustrating a configuration of air shielding plates in FIG. 3.

### BEST MODE FOR CARRYING OUT THE INVENTION

Hereinafter the embodiments of the present invention are described in detail. However, note that the present invention is not limited to the following embodiments.

### [Raw Materials]

A polymer used in the present invention is not particularly limited, and any known polymer capable of forming a film in the solution casting method is used. That is, a polymer capable of producing a dope for casting is used.

In the cellulose acylate to be used in the present invention, a degree of substitution of hydroxyl group preferably satisfies all of the following formulae (1)-(3). Hereinafter the above cellulose acylate is referred to as TAC.

2.5≦A+B≦3.0 (1)

0≦A≦3.0 (2)

0≦B≦2.9 (3)

In these formulae, A is the degree of substitution of the hydrogen atom of the hydroxyl group for the acetyl group, and B is a degree of substitution of the hydroxyl group for the acyl group with 3-22 carbon atoms. Preferably, at least 90 wt. % of the TAC particles have a diameter from 0.1 mm to 4 mm. Further, the cellulose acylate can be obtained from cotton linter or cotton pulp. The cellulose acylate obtained from the cotton linter is preferable. However, the polymer used in the present invention is not limited to the cellulose acylate.

Solvent compounds for preparing the dope are aromatic hydrocarbon (for example, benzene toluene and the like), halogenated hydrocarbons (for example, dichloromethane, chlorobenzene and the like), alcohols (for example methanol, ethanol, n-propanol, n-butanol, diethylene glycol and the like), ketones (for example acetone, methylethyl ketone and the like), esters (for example, methylacetate, ethylacetate, propylacetate and the like), ethers (for example tetrahydrofuran, methylcellosolve and the like) and the like. In the present invention, the dope refers to the polymer solution and the dispersion liquid obtained by dissolving or dispersing the polymer in the solvent.

Among the above solvent compounds, the preferable solvent compounds are the halogenated hydrocarbons having 1 to 7 carbon atoms, and dichloromethane is most preferably used. In view of physical properties such as a solubility of TAC, a peelability of a casting film from a support, a mechanical strength, optical properties of the film and the like, it is preferable to mix at least one sort of the alcohol having 1 to 5 carbon atoms into the halogenated hydrocarbons. The content of the alcohols is preferably in a range of 2 mass. % to 25 mass. %, and especially in a range of 5 mass. % to 20 mass. % of total solvent compounds in the solvent. As concrete examples of the alcohols, there are methanol, ethanol, n-propanol, isopropanol, n-butanol, and the like. It is preferable to use methanol, ethanol, n-butanol or a mixture thereof.

Recently, in order to reduce the influence on the environment, the solvent which does not contain any dichloromethane is proposed. In this case, ethers with 4 to 12 carbon atoms, ketones with 3 to 12 carbon atoms, esters with 3 to 12 carbon atom, or alcohols with 1 to 12 carbon atoms are preferably used. Usually, the above compounds are properly mixed and used. For instance, the mixture solvent of the methyl acetate, acetone, ethanol and n-butanol can be used. The ethers, ketones, esthers and alcohols may have a cyclic structure, and at least one compound having at least two functional groups thereof (—O—, —CO—, —COO— and —OH) may be used as the solvent.

The cellulose acylate is described in detail in paragraphs [0140]-[0195] of the Japanese Patent Laid-Open Publication No. 2005-104148, and the description can be applied to the present invention. Further, details of the solvent of cellulose acylate and additives, such as plasticizers, deterioration inhibitor, ultraviolet absorbing agent (UV agent), optical anisotropy controlling agent, retardation controlling agent, dye, matting agent, peeling agent and peeling promotion agent, are disclosed in paragraphs [0196] to [0516] of Japanese Patent Laid-Open Publication No. 2005-104148.

[Production of Dope]

A dope is produced from the above raw materials. First, a solvent is fed to a mixing tank. Next, TAC is fed to the mixing tank while being measured. Thereafter, a necessary amount of previously prepared additive solution is fed to the mixing tank. Other than feeding the additive in the form of solution, for instance, when the additive is liquid at room temperature, the additive can be fed to the mixing tank in the liquid form. Further, when the additive is solid, it is possible to use the hopper and the like to feed the additive to the mixing tank. To add several additives, the several additives can be previously dissolved in the additive solution. Also, plural additive solution tanks, each of which is filled with the solution containing a different additive, can be used. Each solution can be fed to the mixing tank through an independent isolated pipe.

In the above description, the solvent (including the mixture solvent), the TAC and the additive are put into the mixing tank in this order. However, the order is not limited to the above. For instance, a preferable amount of the solvent can be put into the mixing tank after the TAC is put into the mixing tank while being measured. Further, it is not necessary to put the additive in the mixing tank in advance. The additive can be mixed at a later time to the mixed compound of the TAC and the solvent. Hereinafter, the mixed compound mixed in this order is also referred to as the dope.

A jacket is attached to the mixing tank, and a first stirring blade is provided in the mixing tank. Further, it is preferable to attach a second stirring blade rotated by a motor to the mixing tank. The first stirring blade is preferably an anchor blade, and the second stirring blade is preferably of a dissolver type. It is preferable to regulate the temperature inside the mixing tank in a range of −10° C. to 55° C. by passing a heat transfer medium through the jacket. A swelling liquid, in which the TAC is swelled in the solvent, is obtained by properly selecting and rotating the first and second stirring blades.

The swelling liquid is fed to a heater using a pump. It is preferable to use the pipe with the jacket for the heater, and is more preferable to have a structure for pressurizing the swelling liquid. The dope is obtained by dissolving the TAC and the like in the solvent under conditions that the swelling liquid is heated, or pressurized and heated. In this case, a heat-dissolving method is preferable in which the temperature of the swelling liquid is heated in a range of 40° C. to 120° C. Or, a cool-dissolving method can also be used in which the swelling liquid is cooled in a range of −100° C. to −30° C. It becomes possible to sufficiently dissolve the TAC in the solvent by properly selecting one of the heat-dissolving method and the cool-dissolving method. After the temperature of the dope is adjusted at an approximate room temperature by the heater, impurities in the dope are removed by filtering through a filtration device. An average pore diameter of a filter of the filtration device is preferably 100 μm or less. Further, filtration flow volume is preferably at least 50L/hr.

However, the above method in which the TAC is dissolved after preparing the swelling liquid requires a longer time as the concentration of the TAC is increased and may result in increasing the cost. In this case, it is preferable to carry out a concentration process in which the dope of the intended TAC concentration is prepared after the preparation of the dope of a lower TAC concentration. In this concentration process, the dope filtered through the filtering process is fed to a flash unit. In the flash unit, a part of the solvent in the dope is vaporized. The solvent vapor is condensed to a liquid by a condenser, and recovered by a recovering device. The recovered solvent is reproduced by the reproduction device as the solvent for the dope preparation and reused. Such reuse is advantageous in terms of cost.

The concentrated dope is extracted from the flash unit through a pump. Further, it is preferable to remove foams in the dope. Any known method, for instance, the ultrasonic irradiation method, can be used for removing the foams. Thereafter, the dope is fed to the filtration device and the impurities are removed by the filtration device. At that time, the temperature of the dope is preferably from 0° C. to 200° C. Thus, the dope can be produced with the TAC concentration of 5 mass. % to 40 mass. %, more preferably 10 mass. % to 30 mass. % and the most preferably 15 mass. % to 25 mass. %.

Materials, raw materials, dissolving and adding methods of additives, filtration methods, removal of foams and the like for the dope production method in the solution casting method for producing the TAC film are described in detail in paragraphs [0517]-[0616] of the Japanese Patent Laid-Open Publication No. 2005-104148 and the description can be applied to the present invention.

[Solution Casting Method]

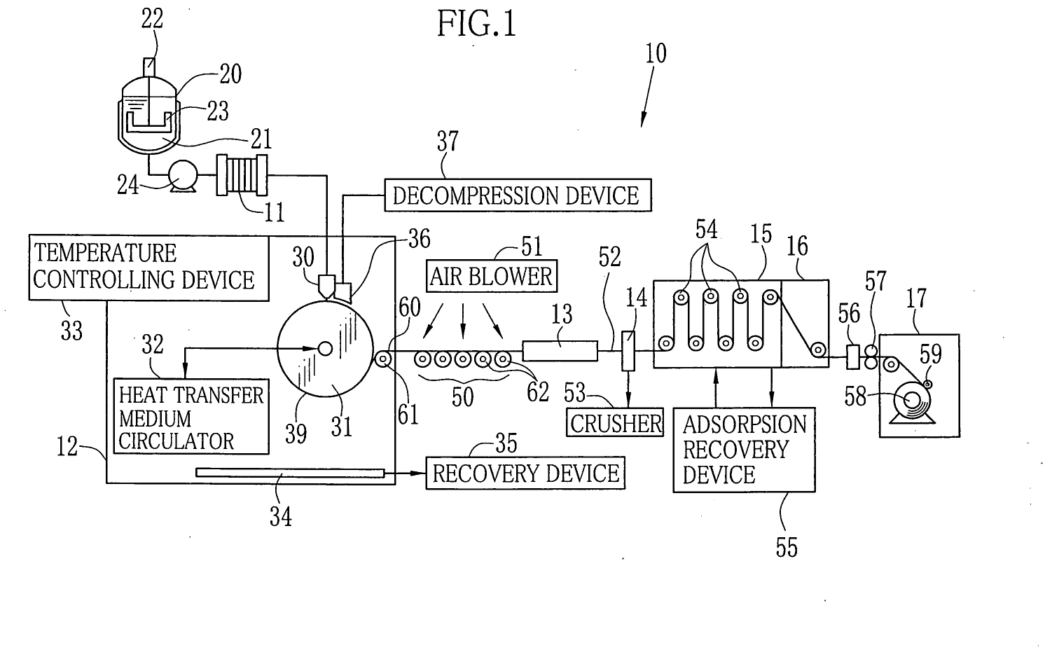

FIG. 1 illustrates a film production line 10. In the film production line 10, a filtration device 11, a casting chamber 12 and a tenter dryer 13 are provided. Further an edge slitting device 14, a drying chamber 15, a cooling chamber 16 and a winding chamber 17 are disposed in the film production line 10.

The dope 21 prepared in the above method is put in the stock tank 20. Further, the stirring blade 23 rotated by the motor 22 is attached to the stock tank 20. By rotating the stirring blade 23, the dope 21 is constantly uniform. The stock tank 20 is connected to the filtration device 11 through a pump 24. Additives such as the plasticizer, the ultraviolet absorbing agent and the like can be mixed to the dope 21 in the stock tank 20.

A precipitation hardened stainless steel is preferable for the material of a casting die 30. The material preferably has a coefficient of thermal expansion at most 2×10⁻⁵(° C.⁻¹). Further, the material with the almost same anti-corrosion properties as SUS316 in examination of corrosion in electrolyte solution can also be used. Further, the material has the anti-corrosion properties which do not form pitting (holes) on the gas-liquid interface after having been dipped in a mixture liquid of dichloromethane, methanol and water for three months. Further, it is preferable to manufacture the casting die 30 by grinding the material which passed more than a month after casting. Thereby, the dope is cast onto the casting die 30 uniformly. Accordingly, streaks and the like in the casting film are prevented, as will be described later.

It is preferable that the finish precision of a contacting surface of the casting die 30 to the dope is 1 μm/m or less of the surface roughness, and the straightness is 1 μm/m or less in any direction. Clearance of the slit is automatically controlled in the range from 0.5 mm to 3.5 mm. An end of the contacting portion of each lip of the casting die 30 to the dope was processed so as to have a chamfered radius at 50 μm or less through the slit. Further, it is preferable to adjust the shearing speed in the die in a range of 1(1/sec) to 5000(1/sec).

A width of the casting die 30 is not restricted in size; however, the width of the casting die 30 is preferably in the range between 1.01 times and 1.3 times larger than a width of the film as an end product. Further, it is preferable to install a temperature controlling device to the casting die 30 for maintaining a predetermined temperature during the production of the film. Further, the casting die 30 is preferably of a coat hanger type. Further, it is preferable to provide bolts (heat bolts) at predetermined intervals in the width direction of the casting die 30 for adjusting the thickness of the film, and provide an automatic thickness control mechanism using the heat bolts. When using the heat bolts in the film production, it is preferable to set the profile according to the flow volume of the pumps (high-precision gear pump is preferable) 24 based on the previously set program. Further, in the film production line 10, it is also possible to carry out a feedback control based on an adjustment program according to a profile of a thickness gauge, for instance, an infrared thickness gauge (not shown). A difference in the thickness between two arbitrary points is preferably adjusted within 1 μm except for the casting edge portion, and the maximum difference in the minimum values of the thickness in the widthwise direction is 3 μm or less. Further, the thickness accuracy is preferably adjusted at ±1.5 μm or less.

Further, it is more preferable that lip ends of the casting die 30 are provided with a hardened layer. In order to provide the hardened layer, there are methods of ceramic coating, hard chrome plating, nitriding treatment and the like. When the ceramics is used as the hardened layer, the ceramic, which is grindable but not friable, with a lower porosity and the good corrosion resistance, is preferred. The ceramic which sticks to the casting die 30 but does not stick to the dope is preferable. For instance, as the ceramics, tungsten carbide, Al₂O₃, TiN, Cr₂O₃ and the like can be used, and especially tungsten carbide (WC) is preferable. A tungsten carbide coating is performed in a spraying method.

The dope discharged to the both edges of a slit of the casting die 30 is partially dried and becomes solid. In order to prevent the solidification of the dope, it is preferable to dispose solvent supplying devices (not shown) at both edges of the slit of the casting die 30. It is preferable to supply a solvent which solubilize the dope (for instance, a mixture solvent of dichloromethane 86.5 pts. mass, acetone 13 pts. mass and n-butanol 0.5 pts. mass.) to bead edges and to an air-liquid interface of the slit. It is preferable to supply the solvent in the range from 0.1 mL/min to 1.0 mL/min to each of the bead edges so as to prevent the impurities from being mixed in the casting film. It is preferable to use a pump with a pulsation of 5% or less for supplying the dope.

Below the casting die 30, a casting drum 31 used as the support is provided. The casting drum 31 is rotated by a driving unit (not shown). Further, to set a surface temperature of the casting drum 31 at a predetermined value, a heat transfer medium circulator 32 is attached to the casting drum 31. In the casting drum 31, a heat transfer medium passage (not shown) is formed. The casting drum 31 can be kept at the predetermined temperature by passing the heat transfer medium kept at the predetermined temperature through the heat transfer medium passage. The surface temperature of the casting drum 31 is not particularly limited, but is preferably in a range of −20° C. to 40° C. By setting the surface temperature in the above range, the time for the casting film to have the self supporting property is shortened to improve the production efficiency of the film.

The width of the casting drum 31 is not particularly limited, but is preferably in the range from 1.05 times to 1.5 times larger than the width of the casting film. It is preferable that the polishing is made such that a surface roughness is 0.05 μm or less. The material is preferably a stainless steel, and more preferably SUS 316 which offers sufficient corrosion resistance and strength.

As the support, a casting belt supported and rotated by a roller can be used instead of the casting drum 31. It is necessary to minimize the surface defect of the support (the casting drum 31 and the belt). Concretely, the number of pin holes whose diameter is 30 μm or less is preferably zero. The number of pinholes whose diameter is 10 μm or more and less than 30 μm is preferably 1 or less per 1 m². The number of pinholes whose diameter is less than 10 μm is 2 or less per 1 m².

The casting die 30 and the casting drum 31 are accommodated in a casting chamber 12. A temperature controlling device 33 is installed to maintain a predetermined temperature in the casting chamber 12. The temperature of the casting chamber 12 is preferably in a range of −10° C. to 57° C. Further, a condenser 34 is disposed to condense organic solvent vapor. The condensed organic solvent is recovered by a recovery device 35. The organic solvent is reproduced by a reproduction device (not shown) and reused as the solvent for the dope preparation. Further, a decompression chamber 36 is attached to the casting die 30 for adjusting the pressure in the upstream area from the casting bead in the support moving direction. In the decompression chamber 36, a decompression device 37 is attached to adjust the decompression degree in the upstream area from the casting bead. Note that the casting die 30, the decompression chamber 36 and the decompression device 37 will be described in detail later.

In a transfer section 50, an air blower 51 is provided. Further, in the downstream from the tenter dryer 13, the edge slitting device 14 is disposed. A crusher 53 for crushing the side edge portions (referred to as edges) into chips is connected to the edge slitting device 14.

In the drying chamber 15, a plurality of rollers 54 are disposed. The drying chamber 15 is also provided with an adsorption recovery device 55 for adsorbing and recovering the solvent gas generated by the solvent evaporation. Further, a humidification chamber (not shown) may be provided between the drying chamber 15 and the cooling chamber 16. Further, in the downstream from the cooling chamber 16, a compulsory neutralization device (a neutralization bar) 56 is provided for adjusting the charged voltage of the film 52 in the predetermined range (for instance, from −3 kV to +3 kV). In FIG. 1, the compulsory neutralization device 56 is disposed in a downstream from the cooling chamber 16. However, the position of the compulsory neutralization device 56 is not restricted in this figure. Further, in this embodiment, it is preferable to provide a knurling roller 57 as necessary in the downstream from the compulsory neutralization device 56 for forming knurling on the both edge portions of the film 52 by an embossing processing. Inside the winding chamber 17, a winding shaft 58 for winding the film 52 and a press roller 59 for controlling the tension at the winding are provided.

Next, an example of the above film production method utilizing the film production line 10 is described in the following. The dope 21 is uniformly mixed by the rotation of the stirring blade 23. During this mixing process, additives such as the plasticizer, the ultraviolet absorbing agent and the like can be added to the dope 21.

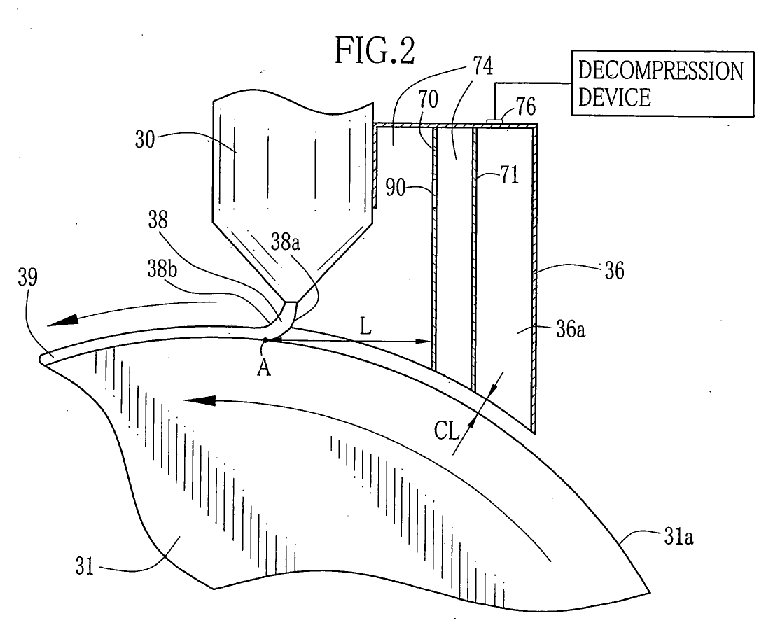

The dope 21 is fed to the filtration device 11 by the pump 24 and filtered. Thereafter, as shown in FIG. 2, the dope 21 is cast from the casting die 30 to the casting drum 31 to form the casting film. The velocity fluctuation of the casting drum 31 is preferably 3% or less of the average velocity. The film meandering in widthwise direction per one rotation of the casting drum 31 is preferably 3 mm or less. The position fluctuation in the up-and-down direction of the casting drum 31 directly below the casting die 30 is preferably adjusted to be 500 μm or less. The temperature of the casting chamber 12 is preferably controlled from −10° C. to 57° C. by the temperature controlling device 33. Further, the solvent evaporated in the casting chamber 12 is recovered by the recovering device 35 and reproduced, and then reused as the solvent for the dope preparation.

The dope 21 from the casting die 30 to the casting drum 31 is referred to as a casting bead 38. The temperature of the dope 21 at the casting is preferably from −10° C. to 57° C. Further, in order to stabilize the formation of the casting bead 38, the upstream side 38a area of the casting bead 38 is adjusted at a predetermined pressure by the decompression chamber 36. The pressure in the upstream side 38a area is preferably reduced in a range of (atmospheric pressure—2000)Pa to (atmospheric pressure—10)Pa. Further, a jacket (not shown) is preferably attached to the decompression chamber 36 to keep the predetermined temperature. The temperature of the decompression chamber 36 is not especially restricted. However, the temperature of the decompression chamber 36 is preferably set above the condensation point of the solvent used. Further, a suction device (not shown) is preferably disposed in the side edge portions of the casting die 30 to keep the casting bead 38 in a desired shape. An edge suction flow volume is preferably in a range of 1L/min to 100L/min.

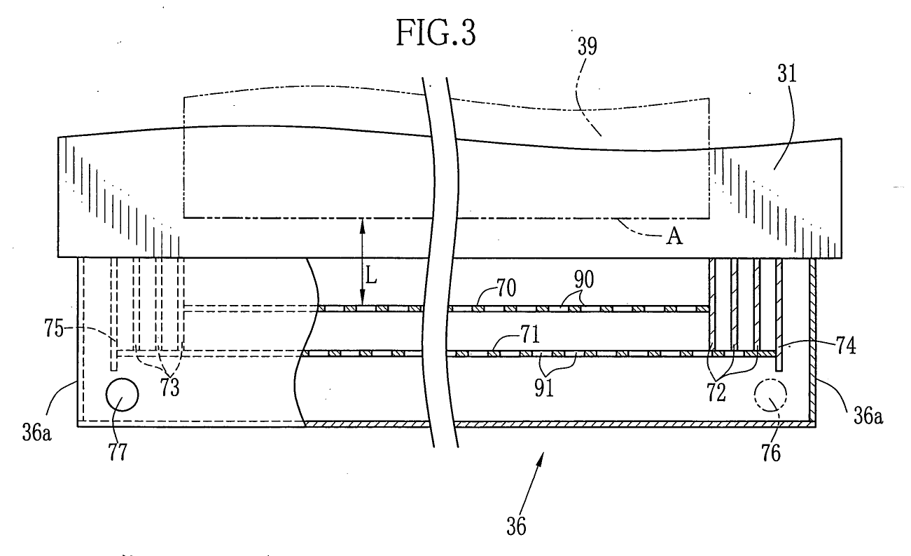

As shown in FIG. 2, the decompression chamber 36 is disposed in the upstream from the casting die 30 in the moving direction of the casting drum 31. As shown in FIG. 3, first and second air shielding plates 70, 71 are provided in the decompression chamber 36. The first and second air shielding plates 70, 71 extend in the casting width direction in standing postures in the decompression chamber 36 to partition the inside of the decompression chamber 36. The air shielding plates are designated as first, second air shielding plates and so forth from the casting bead 38. The first and second air shielding plates 70, 71 prevent the generation of the air flow. Even if a small amount of the air flow is generated, such air flow is rectified and shielded by the first and second air shielding plates 70, 71. Note that the first and second air shielding plates 70, 71 may not be vertical to the horizontal direction.

The positions of the first and second air shielding plates 70, 71 can be changeable in the moving direction of the casting drum 31. For instance, a plurality of grooves can be formed in the width direction of the casting bead 38 in both upper and lower inner walls of the decompression chamber 36 to fit in the first and second air shielding plates 70, 71. The positions of the first and second air shielding plates 70, 71 can be changed by changing the grooves to which the first and second air shielding plates 71, 71 are fit in.

Further, the side plates (hereinafter referred as side shielding plates) 72, 73 are attached in the decompression chamber 36 for preventing the air flow through both end portions of the first and second air shielding plates 70 and 71. Furthermore, outermost side shielding plates 74 and 75 are attached to the air shielding plate 71 outside the side shielding plates 72 and 73. The side shielding plates 72, 73 and the outermost side shielding plates 74, 75 are approximately parallel to each other, and are approximately perpendicular to the first and second air shielding plates 70, 71. A numeral 36a is a side wall of the decompression chamber 36, approximately perpendicular to the air shielding plates 70, 71. Further, the decompression device 37 is connected to the decompression chamber 36 to suck the air from inside the decompression chamber 36. Air outlets 76, 77 which are ventilation openings during the air suction are provided in the upstream from the second air shielding plate 71 with respect to the support moving direction.

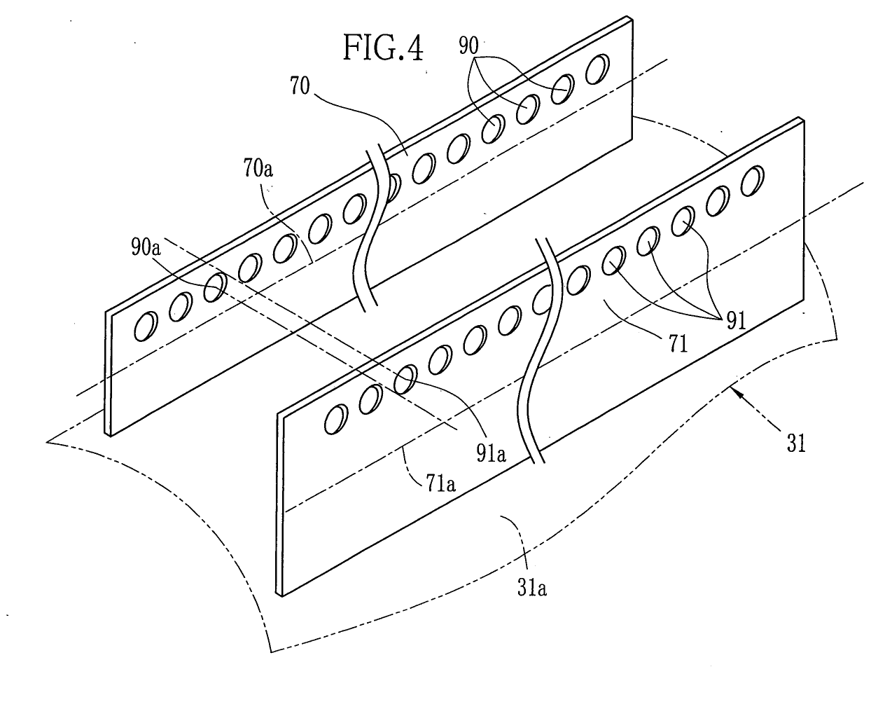

As shown in FIG. 4, plural openings 90, 91 are respectively formed in the first and second air shielding plates 70, 71 to pass the air flow. Shapes of the openings 90 and 91 are not restricted to circular shapes as shown in FIG. 4. Oval shapes, rectangular shapes including square shapes and the like, polygonal shapes or other shapes can be adopted. The openings 90, 91 are formed at the same pitch in the width direction of the casting bead 38. Centers 90a, 91a of the openings 90, 91 are preferably arranged in a staggered arrangement (see FIG. 3) in the width direction in order not to horizontally oppose the openings 90, 91. Since the centers 90a, 91a of the openings 90, 91 are not aligned in the rotation direction of the casting drum 31 and not horizontally opposed to each other, the air flow passage is not formed. Accordingly, both the fluctuations in the decompression degree inside the decompression chamber 36 in the width direction of the casting bead 38, and the fluctuations in the pressure at an arbitrary point in the decompression chamber 36 are prevented, and the pressure in the upstream side 38a area can be reduced uniformly. Further, the generation of the air flow is also prevented.

In the present invention, the openings 90 and 91 are preferably formed in the upper half portion of the air shielding plates 70, 71 from the centerlines 70a and 71a in the width direction of the air shielding plates 70, 71. Thereby, the influence of the air flow on the casting bead 38 is effectively prevented. This is because even if the air flow is generated, such air flow is effectively shifted in a direction away from the upstream side 38a area and discharged outside by providing the openings 90, 91 in the upper half portion of the air shielding plates 70, 71. Further, thereby, the generation of the air flow is also prevented.

The area ratio of each of the openings 90, 91 to each of the first and second air shielding plates 70, 71 (hereinafter referred to as an opening ratio) is preferably from 5% to 30%, more preferably from 10% to 25% and most preferably from 15% to 20%. Note that the area of the first air shielding plate 70 is defined as S1 which is the area of the largest surface when there are no openings 90 in the first air shielding plates 70. The area of the second air shielding plate 71 is the same as the first air shielding plate 70. When an area of the opening 90 or that of the opening 91 is defined as S2, the number of the openings 90 or that of the openings 91 is defined as n, the opening ratio is calculated by a formula {(n×S2)/S1}×100, given that the openings 90 or the openings 91 are of the same size. When the opening ratio is less than 5%, the air may not be discharged efficiently. Further, when the opening ratio excesses 30%, the load in the decompression chamber 37 may reach an excessive value while increasing the decompression degree, in other words, decreasing the absolute pressure in the decompression chamber 36.

In FIGS. 2 and 3, a contact position A is shown on which the casting bead 38 comes in contact with the casting drum 31. Further, in FIG. 3, the contact position A is shown as an approximate straight line. However, the contact position A is usually concave in which center portions of the both sides of the casting bead 38 parallel to the width direction of the support are slightly shifted toward the moving direction of the casting drum 31. Since the casting bead 38 extends at the casting, the contact position A is shifted in the moving direction of the casting drum 31. In the present invention, the distance L (mm) is defined as the distance between the air shielding plate 70 and the contact position A. In the present invention, to define the distance L (mm), the contact position A is used which is located in the most upstream of the casting drum 31 with respect to the moving direction of the casting drum 31. When the contact position A is a concave line, the most upstream position in the contact position A is used to define the distance L (mm).

The distance L (mm) is preferably from 20 mm to 100 mm, and more preferably from 20 mm to 80 mm, most preferably from 20 mm to 40 mm. When the distance L (mm) is less than 20 mm, the casting bead 38 may come in contact with the air shielding plate 70. Further, when the distance L (mm) is too short, the decompression degree in the decompression chamber 36 may not be adjusted within a predetermined range. When the distance L (mm) excesses 100 mm, the effect of discharging the air by the air shielding plate 70 may be decreased, or may not be produced at all.

In FIGS. 2 to 4, the air shielding plates 70, 71 dispsosed close to the contact position A are shown. In the present invention, only the first air shielding plate 70 disposed close to the contact position A enables to prevent the air flow without the use of the second air shielding plate 71. Even if the air flow is generated by the rotation of the casting drum 31, the air is discharged without flowing onto the casting bead 38.

Further, in the present invention, the number of the air shielding plates is not limited to two, and it is preferable to use three or more air shielding plates. The number of the air shielding plates is not particularly limited. However, the air shielding plates are preferably from two to eleven, more preferably from two to six and most preferably two to four. When more than twelve air shielding plates are used, the decompression chamber 36 should be extended in the support direction or the intervals between the air shielding plates should be shortened. In the former, problems arise such as a difficulty in installation of the decompression chamber 36, upsizing of the decompression chamber 36 or the like. In the latter, the added air shielding plates in the upstream of the first and second air shielding plates 70, 71 become baffle plates which interfere the air flow in the decompression chamber 36. Accordingly, it becomes difficult to set the decompression degree in the predetermined range in the decompression chamber 36. As a result, the solvent gas generated from the casting bead 38 may cause condensation on the air shielding plates and inner walls of the decompression chamber 36 so that the solvent may adhere to the air shielding plates.

In the present invention, the casting bead 38 with the excellent surface condition and the uniform thickness is formed by stabilizing the air flow in the upstream side 38a area. To stabilize the air flow, a clearance CL (mm) between the casting drum 31 (the support) and the decompression chamber 36 is narrowed. Thereby, the instability of the air flow in the upstream side 38a area is prevented. It is effective to narrow the clearance CL (mm) as much as possible for preventing the instability of the air flow. However, the height of the surface 31a of the casting drum 31 fluctuates during the rotation in accordance with the unevenness in the rotation. In consideration of preventing the decompression chamber 36 from contacting the casting drum 31, the clearance CL (mm) is preferably in a range of 0.05 mm to 3.0 mm, more preferably in a range of 0.05 mm to 0.7 mm, and most preferably in a range of 0.05 mm to 0.5 mm.

Further, in the present invention, the moving speed of the casting drum 31 (the support) is preferably in a range of 30 m/min to 150 m/min, more preferably in a range of 50 m/min to 120 m/min, and most preferably in a range of 70 m/min to 110 m/min. When the moving speed is less than 30 m/min, the productivity of the film 52 becomes low. When the moving speed excesses 150 m/min, it may become difficult to prevent the air flow from flowing onto the casting bead 38 even if the decompression chamber 36 of the present invention is used.

Upon obtaining a self supporting property, the casting film 39 is peeled off as a wet film 60 from the casting drum 31 with the support of a peel roller 61. Thereafter, the wet film 60 is transported to a tenter dryer 13 through a transfer section 50 with a plurality of rollers 62. In the transfer section 50, drying air at a predetermined temperature is fed from an air blower 51 to proceed drying of the wet film 60. The temperature of the drying air is preferably in a range of 20° C. to 250° C. Note that in the transfer section 50, it is possible to draw the wet film 60 in the transporting direction by setting the rotational speed of each roller 62 faster than the adjacent roller 62 in the upstream.

The wet film 60 is transported to a tenter dryer 13 and is dried while both side edges are held by the clips. It is preferable to separate inside the tenter dryer 13 into different temperature zones to adjust the drying conditions. It is also possible to stretch the wet film 60 in the width direction by using the tenter dryer 13. Thus, it is preferable to stretch the wet film 60 in at least one of the casting direction and the width direction in the transfer section 50 and/or the tenter dryer 13 in a range of 0.5% to 300%.

The wet film 60 is dried until the volatile amount reaches a predetermined value through the tenter dryer 13 and then fed as a film 52. Both side edge potions of the film 52 are slit by an edge slitting device 14. The cut edge portions of the film 52 are transported to a crusher 53 by a cutter blower (not shown). The crusher 53 crushes the edge portions of the film 52 into chips. In terms of cost, it is advantageous to reuse the chips for preparing the dope. This step for cutting the both edge portions of the film 52 may be omitted; however, it is preferable to cut the both edge portions of the film 52 in one of the processes between the casting process and the film winding process.

Next, the film 52 is transported into a drying chamber 15 in which a plurality of rollers 54 are disposed. The temperature of the drying chamber 15 is not especially restricted; however, it is preferable to be in a range of 50° C. to 160° C. In the drying chamber 15, the film 52 is dried while being conveyed by the rollers 54 in such a way that the film 52 comes in contact with the rollers 54 to evaporate the solvent. The evaporated solvent (solvent gas) is adsorbed and recovered by the adsorption recovery device 55. The air from which the solvent vapor is removed is fed to the drying chamber 15 as the drying air again. Note that the drying chamber 15 is preferably separated into plural partitions so as to vary the drying temperature. Further, it is preferable to provide a pre-drying chamber (not shown) between the edge slitting device 14 and the drying chamber 15 to pre-dry the film 52. Thereby, the deformation of the film 52 is prevented which is caused by the accelerated increase in the film temperature.

The film 52 is transported to a cooling chamber 16, and cooled to an approximate room temperature. Note that a humidification chamber (not shown) may be provided between the drying chamber 15 and the cooling chamber 16. In the humidification chamber, an air whose moisture and temperature are controlled at desired values is blown onto the film 52. Thus curling of the film 52 and the winding defect at the time of winding the film 52 are prevented.

It is preferable to provide a compulsory neutralization device (neutralization bar) 56 such that the charged voltage is kept in the predetermined range (for instance, −3 kV to +3 kV) while transporting the film 52. In FIG. 1, the neutralization device 56 is disposed in a downstream of the cooling chamber 16. However, the position of the neutralization device 56 is not restricted in this figure. Further, it is preferable to provide a knurling roller 57 for providing knurling by the embossing processing on the both edge portions of the film 52. Note that each height of the projections and each depth of the depressions in the knurled area are preferably in a range of 1 μm to 200 μm respectively.

Lastly, the film 52 is wound around a winding shaft 58 in a winding chamber 17. The winding is preferably made with applying a predetermined tension by a press roller 59, and it is preferable to gradually change the tension from a start to an end of the winding. The length of the film 52 to be wound is preferably at least 100 m in the lengthwise direction (casting direction), and a width thereof is preferably at least 600 mm, and especially preferable in a range of 1400 mm to 1800 mm. However, the present invention is also effective when the width is more than 1800 mm. Further, the present invention can also be applied to the production of the thin film with the thickness in a range of 15 μm to 100 μm.

In the solution casting method of the present invention, an endless belt can also be used for the support instead of the casting drum 31.

The solution casting method of the present invention may be a co-casting method in which two or more sorts of the dopes are simultaneously cast, or a sequentially casting method in which two or more sorts of the dopes are sequentially cast. Further, the co-casting method and the sequentially casting method are utilized in combination. When the co-casting is performed, the casting die with the feed block or a multi-manifold type casting die can be used. In the multi-layer film produced by the co-casting method, the thickness of at least one of the layers on the support side and on its opposite side is preferably in a range of b 0.5% to 30% to the total thickness of the multi-layer film. Furthermore, in the co-casting method, when the dope is cast onto the support, it is preferable that the lower viscosity dopes may entirely cover over the higher viscosity dope. Furthermore, in the co-casing method, when the dope is cast onto the support, it is preferable that the inner dope is covered with dopes whose alcohol contents are higher than the inner dope.

Note that paragraphs from [0617] to [0889] of Japanese Patent Laid-Open Publication No. 2005-104148 describe in detail the structures of the casting die, the decompression chamber and the support, and co-casting, the peeling, the stretching, the drying condition in each process, a handling method, curling, a winding method after the correction of planarity, a recovering method of the solvent, and a recovering method of film, which can be applied to the present invention.

[Characteristics, Measuring Method]

(Curling Degree and Thickness)

Paragraphs from [0112] to [0139] of the Japanese Patent Laid-Open Publication No. 2005-104148 teach the characteristics and the measuring method of the cellulose acylate film, which can be applied to the present invention.

[Surface Treatment]

It is preferable to make a surface treatment of at least one surface of the cellulose acylate film. Preferably, the surface treatment is at least one of vacuum glow discharge treatment, atmospheric plasma discharge treatment, UV radiation treatment, corona discharge treatment, flame treatment, acid treatment and alkali treatment.

[Functional Layer]

### (Antistatic, Hardening Layer, Antireflection, Easy Adhesion and Antiglare)

A primary coating may be made over at least one surface of the cellulose acylate film.

Further, it is preferable to use the cellulose acylate film as a base film and provide other functional layers for the cellulose acylate film so as to obtain a functional material. At least one of an antistatic layer, a cured resin layer, an antireflection layer, an adhesive layer for easy adhesion, an antiglare layer and an optical compensation layer is preferably used as the functional layer.

Preferably, the functional layer contains at least one sort of surfactant in a range of 0.1 mg/m² to 1000 mg/m². More preferably, the functional layer contains at least one sort of lubricant in a range of 0.1 mg/m² to 1000 mg/m². Further, preferably, the functional layer contains at least one sort of matting agent in a range of 0.1 mg/m² to 1000 mg/m². Furthermore, preferably, the functional layer contains at least one sort of antistatic agent in a range of 1 mg/m² to 1000 mg/m². Methods for performing a surface treatment on the cellulose acylate film to achieve various functions and characteristics are described in paragraphs [0890] to [1087] of Japanese Patent Laid-Open Publication No. 2005-104148 including the conditions and methods in detail, which can be applied to the present invention.

[Application]

The cellulose acylate film is especially useful as the protective film for a polarizing filter. To produce the LCD device, two polarizing filters are disposed so as to sandwich a liquid crystal layer. Each polarizing filter has the cellulose acylate film adhered to a polarizer. Note that the configuration of the liquid crystal layer and the polarizing filters are not limited to the above example and other known configurations can be used. Japanese Patent Laid-Open Publication No. 2005-104148 discloses TN type, STN type, VA type, OCB type, reflection type, and other examples of the LCD devices in detail. These types can be applied to the present invention. Further, the application teaches the cellulose acylate film provided with an optical anisotropic layer and that provided with antireflective and antiglare functions. Further, the application discloses to provide the cellulose acylate film with proper optical functions, and thus a biaxial cellulose acylate film is obtained, which is used as the optical compensation film. The optical compensation film also serves as the protective film in the polarizing filter. The description is applied to the present invention. Paragraphs from [1088] to [1265] in Japanese Patent Laid-Open Publication No. 2005-104148 disclose the details.

According to the present invention, the polymer film with the excellent optical properties can be produced. Especially, when the cellulose triacetate (TAC) is used as the polymer, the TAC film obtains superior optical properties. The TAC film can be used as the protective film in the polarizing filter and the base film for the photosensitive material. Further, the TAC film can be used as an optical compensation film for widening a view angle of the LCD device used for the television and the like. In particular, the TAC film is effective in the application where the TAC film serves as the optical compensation film and also as the protective film of the polarizing filter. Accordingly, the TAC film can be used for an IPS mode, an OCB mode, a VA mode and the like as well as for a conventional TN mode. Further, it is also possible to form the polarizing filter using the protective film in the polarizing filter.

### Embodiment 1

The embodiment 1 is described in the following. However, the present invention is not limited to the embodiment 1. Note that the detailed explanations are given in the experiment 1. Regarding the experiments 2 to 17 according to the present invention and the comparison experiment 18, experiment conditions and the results will be shown together in Table 1.

Each pts. mass of raw materials used in the embodiment 1 is as follows.

[Composition]

| | | |
|---|---|---|
| Cellulose triacetate (fine particles whose degree of | 100 | pts. mass |
| substitution is 2.84, viscometric average degree of | | |
| polymerization is 306, moisture content is | | |
| 2.0 mass %, viscosity of 6 mass % of dichloromethane | | |
| solution is 315 mPa · s, average particle diameter | | |
| is 1.5 mm and average variation of the particle | | |
| diameter is 0.5 mm) | | |
| Dichloromethane (first solvent) | 384 | pts. mass |
| Methanol (second solvent) | 94 | pts. mass |
| 1-Butanol (third solvent) | 2 | pts. mass |
| Plasticizer A (Triphenylphosphate) | 7.6 | pts. mass |
| Plasticizer B (diphenylphosphate) | 3.8 | pts. mass |
| UV agent a | | |
| 2-(2′-hydroxy-3′,5′-di-tert-butylphenyl) benzotriazol | 0.7 | pts. mass |
| UV agent b | | |
| 2-(2′-hydroxy-3′,5′-di-tert-amylphenyl)-5- | 0.3 | pts. mass |
| chlorobenzotriazol | | |
| Citric acid ester mixture (citric acid, citric acid | 0.006 | pts. mass |
| monoethyl ester, citric acid diethyl ester and citric | | |
| acid triethyl ester) | | |
| Fine particles (silicon dioxide, particle diameter: | 0.05 | pts. mass |
| 15 nm, Mohs hardness: approximately 7) | | |

[Cellulose Triacetate]

The cellulose triacetate (TAC) used in this embodiment contains the following: remaining amount of acetic acid was 0.1 mass % or less, Ca content was 58 ppm, Mg content was 42 ppm, Fe content was 0.5 ppm, free acetic acid was 40 ppm and sulphate ion was 15 ppm. Further, substitution of the acetyl group at the sixth position was 0.91, and was 32.5% of the acetyl group. Further, extraction of acetone was 8 mass %. A ratio of weight average molecular weight/number average molecular weight was 2.5. Further, yellow index was 1.7. Haze was 0.08. Transparency was 93.5%. Tg (glass transition temperature measured by DSC) was 160° C. The heating value of crystallization was 6.4 J/g. This TAC was chemically synthesized from cellulose extracted from cotton. Hereinafter, this TAC is referred to as cotton derived TAC.

The above mentioned plural solvents are mixed and stirred in the 4000L stainless steel mixing tank with the stirring blade to prepare mixture solvents. Note that the moisture content of each solvent was 0.5 wt. % or less. Next, the TAC powder (flake) is gradually dispensed from the hopper into the 4000L stainless steel mixing tank and dispersed for 30 minutes using the eccentric stirring shaft of the dissolver type (the peripheral speed of 1 m/sec) and the anchor blade (the peripheral speed of 0.5 m/sec). Temperature at the start of the dispersion was 25° C. and finally reached 48° C. Further, the previously prepared additive solution is dispensed into the mixing tank to prepare 2000 kg of the mixture solvent as a whole. After the dispersion of the additive solution is completed, high-speed stirring is stopped. Still, stirring by the anchor blade is continued for 100 minutes at the peripheral speed of 0.5 m/sec. Thereby, the TAC flake was swelled to obtain the swelling liquid. The pressure was applied to the mixing tank using nitrogen gas to keep the inside of the mixing tank at 0.12 MPa until the completion of the swelling. An oxygen concentration inside the mixing tank is less than 2 vol. %, which kept the tank free from explosion. The moisture content in the swelling liquid is 0.3 mass %.

The swelling liquid is fed from the mixing tank to the pipe with the jacket through a pump. Through the pipe with the jacket, the swelling liquid is heated to 50° C., further heated to 90° C. through the application of pressure of 2 MPa and completely dissolved. The heating time was 15 minutes. Then the temperature of the swelling liquid is lowered to 36° C. by the temperature controlling device. Thereafter, the swelling liquid is passed through the filtration device formed of filtration media with nominal pore diameter of 8 μm to obtain a dope (hereinafter referred to as a dope before concentration). At this time, the pressure in the upstream of the filtration device was 1.5 MPa and the pressure in the downstream of the filtration device was 1.2 MPa. Further, the filter, the housing and the pipe which are exposed to high temperature are made of hastelloy alloy to be superior in corrosion resistance, and provided with jackets in which heat transfer medium is circulated for insulation and heating.

The dope before concentration is flashed in the flash unit kept at a normal pressure at 80° C. to vaporize the solvent. The solvent vapor is recovered by the condenser. The solid content concentration of the dope after the flash is 22.5 mass %. Note that the condensed solvent is recovered by the recovery device to be reused as the solvent for the dope preparation. Thereafter, the recovered solvent is reproduced in the reproduction device and fed to the solvent tank. In the recovery device and the reproduction device, distillation and dehydration are carried out. In the flash tank of the flash device, a stirrer with the anchor blade is provided, rotating at a peripheral speed of 0.5 m/sec to remove the foams in the flashed dope. A temperature of the dope in the flash tank is 25° C. An average residence time of the dope in the tank is 50 minutes. The dope is extracted and a shear viscosity is 450 Pa·s measured at 25° C. at a shear rate of 10(1/s).

Next, the foams are removed by irradiating weak ultrasonic waves to the dope. Thereafter, the dope is fed to the filtration device using the pump while applying pressure of 1.5 MPa to the dope. In the filtration device, the dope is passed through a sintered metal fiber filter with a nominal pore diameter of 10 μm, and then the other sintered metal fiber filter of the same size (a nominal pore diameter of 10 μm). Pressures in the upstream of the sintered metal fiber filters are 1.5 MPa and 1.2 MPa respectively. Pressures in the downstream of the sintered metal fiber filters are 1.0 MPa and 0.8 MPa respectively. The temperature of the dope 21 after the filtration is kept at 36° C. and stored in the 2000L stainless steel stock tank 20. The stock tank has the anchor blade 23 on the center axis, and the dope 21 is constantly stirred at the periphery speed of 0.3 m/sec. Note that during the preparation of the dope from the dope before concentration, corrosion and the like did not occur in contact portions of each device contacting the dope.

A film is produced using the film production line 10 as shown in FIG. 1. Next, the d+ope 21 in the stock tank 20 is fed to the filtration device 11 through the high accuracy gear pump 24. The gear pump 24 has a function to boost the primary pressure, and feeds the dope 21 to the filtration device 11 while carrying out a feedback control by an inverter motor to keep the primary pressure of the pump 24 at 0.8 MPa. As the performance capabilities of the high accuracy gear pump 24, the volume efficiency is 99.2%, and the fluctuation ratio of discharge amount is 0.5% or less. The discharge pressure is 1.5 MPa. Thereafter, the dope 21 which has passed through the filtration device 11 is fed to the casting die 30.

The casting die 30 is 1.8 m in width. The casting is carried out while adjusting the flow volume of the dope 21 discharged from the outlet of the casting die 30 such that the dried film has the thickness of 40 μm. Further, the casting width of the dope 21 discharged from the outlet of the casting die 30 is 1700 mm. To regulate the temperature of the dope 21 at 36° C., the jacket (not shown) is attached to the casting die 30 to regulate the temperature of the casting die 30 between 30° C. and 40° C.

The casting die 30 and the pipe are insulated at 36° C. during the casting. The casting die 30 is of a coat hanger type. Further, the casting die 30 is provided with bolts (heat bolts) at 20 mm pitch for adjusting the thickness of the film, and equipped with the automatic thickness control mechanism using the heat bolts. The heat bolts enable to set the profile according to the flow volume of the high-precision gear pump 24 based on the previously set program and to carry out the feedback control based on the adjustment program according to the profile of the thickness gauge such as the infrared thickness gauge (not shown) disposed on the film production line 10. A difference in thickness between two points, which are 50 mm apart, is preferably adjusted within 1 μm except for the casting edge portion (20 mm), and the variations of the thickness in the widthwise direction is 3 μm or less. Further, the average thickness accuracy of the whole film is adjusted to be ±1.5% or less.

In the upstream from the casting die 30 in the-support moving direction, a decompression chamber 36 is disposed. The pressure in the upstream side 38a area from the casting bead 38 is adjusted to be 300 Pa lower than that in the downstream area with respect to the casting bead 38, that is, the atmospheric pressure by using the decompression chamber 36 and the decompression device 37. Further, positions of the decompression chamber 36 and the first air shielding plate 70 are adjusted to set the distance L (mm) between the contact position A and the first air shielding plate 70 at 40 mm (see FIG. 3). Note that the fluctuations in the distance L (mm) during the casting are in a range between 20 mm and 100 mm. The first air shielding plate 70 with the opening ratio of 20% is used. Further, the decompression chamber 36 is disposed such that the clearance CL (mm) between the decompression chamber 36 and the casting drum 31 (the support) is 0.5 mm. Five additional air shielding plates including the second air shielding plate 71 are disposed in the upstream from the first air shielding plate 70 with respect to the moving direction of the casting drum 31. Each interval between the air shielding plates is 7 mm. Further, each of the five additional air shielding plates including the second air shielding plate 71 has the same opening ratio as the first air shielding plate 70, that is, 20%.

The material of the casting die 30 is the precipitation hardened stainless steel. The material had coefficient of thermal expansion of at most 2×10⁻⁵(° C.⁻¹), the almost same anti-corrosion properties as SUS316 in examination of corrosion in electrolyte solution. Further, the material has the anti-corrosion properties which do not form pitting (holes) on the gas-liquid interface after having been dipped in a mixture liquid of dichloromethane, methanol and water for three months. It is preferable that the finish precision of a contacting surface of the casting die 30 is 1 μm/m or less, and the straightness is 1 μm/m or less in any direction. The clearance of the slit is automatically controlled at 1.5 mm. The end of the contacting portion of each lip to the dope was processed so as to have the chamfered radius 50 μm or less through the slit. Further, the shearing speed of the dope 21 in the casting die 30 is adjusted in a range of 1(1/sec) to 5000(1/sec). The lip ends of the casting die 30 are provided with the hardened layer formed by the tungsten carbide (WC) coating in the spraying method.

The dope 21 discharged to casting die 30 may be partially dried and becomes solid. In order to prevent the solidification of the dope 21, the mixture solvent (dichloromethane: methanol=50 pts. mass: 50 pts. mass) which solubilizes the dope 21 is supplied to the edges of the bead 38 and the air-liquid interface of the slit at 0.5 ml/min. It is preferable to use the pump with a pulsation of 5% or less for supplying the dope. Further, a jacket (not shown) is attached to the decompression chamber 36 to keep the internal temperature of the decompression chamber 36 constant at a predetermined temperature. The heat transfer medium, which is regulated at 35° C., is supplied through the jacket. The edge suction flow volume is adjustable in a range of 1L/min to 100L/min. In this embodiment, the edge suction flow volume is properly adjusted in a range of 30L/min to 40L/min.

The casting drum 31 with the diameter of 3 m and the width of 1.5 m is used. The surface material of the casting drum 31 is chrome plated and has sufficient corrosion resistance and strength. The polishing is made such that a surface roughness is 0.05 μm or less. A liquid flow passage is formed in the casting drum 31. The heat transfer medium circulator 32 is provided for supplying the heat transfer medium in the liquid flow passage. The surface temperature of the casting drum 31 is kept at 0° C. or below. Further, fluctuations in the closest distance between the lip of the casting die 30 and the casting drum 31 while rotating, the casting drum 31 for one time (that is, usually the position for casting the dope) is adjusted to be 500 μm or less. Further, the casting drum 31 is disposed in the casting chamber 12 with a device for preventing air pressure fluctuations (not shown). The dope 21 is cast from the casting die 30 onto the casting drum 31.

The surface of the casting drum 31 is preferably defect-free. The surface of the casting drum 31 satisfied the following conditions: the number of pin holes whose diameter is 30 μm or more is zero, the number of pinholes whose diameter is from 10 μm to 30 μm is 1 or less per 1 m², and the number of pinholes whose diameter is less than 10 μm is 2 or less per 1 m².

The temperature of the casting chamber 12 was kept at 35° C. by the temperature controlling device 33. The casting film 39 is dried by feeding the drying air. The saturated temperature of the drying air was about −8° C. The oxygen concentration is kept at 5 vol % in drying atmosphere on the casting drum 31. Further, the nitrogen gas substitutes for the air to keep the oxygen concentration at 5 vol %. Furthermore, the condenser 34 is provided for condensing and recovering the solvent in the casting chamber 12. The outlet temperature of the condenser 34 is set at −10° C.

The air shielding plate (not shown) is provided to prevent the casting bead 38 and the casting film 39 from being directly exposed to the drying air and to the air flow for five seconds after the casting to regulate the fluctuations in static pressure in the immediate area of the casting die 30 at ±1 Pa or less. The casting film 39 is peeled off from the casting drum 31 as a wet film 60 while supported by a peel roller 61 when the solvent ratio in the casting film 39 is 200 mass % (dry measure). Note that the solvent ratio (dry measure) is calculated by a formula, {(x-y)}×100, when x is a weight of a sampling film and y is a weight of dried sampling film. To prevent the peeling defect, the peeling speed is properly adjusted in a range of 103% to 120% with respect to the moving speed of the casting drum 31. The solvent gas generated during the drying process is condensed and liquefied by the condenser at −10° C. and recovered by the recovery device 35. The moisture content of the recovered solvent is adjusted to be 0.5% or less. The drying air from which the solvent is removed is heated again and used as the drying air.

The wet film 60 is then transported to the tenter dryer 13 through the rollers 62 of the transfer section 50. In the transfer section 50, the drying air is fed from the air blower 51 to the wet film 60. Further, Teflon (registered trademark) is used for the surface material of the rollers 62. The surface temperature of the rollers 62 is adjusted at or below 20° C.

The wet film 60 is fed through a drying zone in the tenter dryer 13, while both side edges are held by the clips, and dried by the drying air. The heat transfer medium at 20° C. is supplied to the clips for cooling. The clips are transferred by chains, and the fluctuation in the sprocket speed is 0.5% or less. Further, the tenter dryer 13 is separated into three zones, and a temperature of the drying air in each zone is 90° C., 110° C. and 120° C. from the upstream. The gas composition of the drying air is that of saturated gas concentration at −10° C. Conditions of the drying zone is adjusted in such a way that remaining solvent in the film 52 is 10 mass % at the outlet of the tenter dryer 13. Further, in the tenter dryer 13, the wet film 60 is stretched in the widthwise direction while being fed. A widening ratio is 105% with respect to the width (100%) of the wet film 60 when transported to the tenter dryer 13. A difference in the stretch rates between arbitrary two points which are 10 mm away from the holding portion is 10% or less, and a difference in the stretch rates between arbitrary two points which are 20 mm away from the holding portion is 5% or less. Further, a ratio of the distance between the clip start position and the clip release position to the distance between the inlet and the outlet of the tenter dryer 13 is 90%. The solvent vapor in the tenter dryer 13 is condensed and liquefied at −10° C. and recovered. The condenser (not shown) is disposed for condensing and recovering, and the outlet temperature of the condenser is set at −8° C. The recovered solvent is reused after adjusting the moisture content to be 0.5 wt. % or less. Thereafter, the wet film 60 is transported out of the tenter dryer 13 as the film 52.

The both edge portions of the film 52 are cut by the edge slitting device 14 within 30 seconds after the film 52 passes through the outlet of the tenter dryer 13. Both edge portions of the film 52 are cut by using a NT type cutter at 50 mm from each side edge. The cut edge portions are transported to the crusher 53 by a cutter blower (not shown). The crusher 53 crushes the edge portions into chips with an average size of 80 mm². The chips are used again as the material for the dope production with TAC flakes. An oxygen concentration of the tenter dryer 13 is kept at 5 vol % in an atmosphere of dry air. Further, air is substituted by nitrogen gas to keep the oxygen concentration at 5 vol %.

Before drying the film 52 at a high temperature in the drying chamber 15 which will be described later, the film 52 is preheated in a preheating chamber (not shown) which supplies the drying air of 100° C.

The film 52 was dried at a high temperature in the drying chamber 15. The drying chamber 65 is partitioned into 4 sections, and the hot air is supplied from the air blower (not shown) to each section from the upstream at 120° C., 130° C., 130° C. and 130° C. The tension applied to the film 52 by the roller 52 during the transportation in the drying chamber 15 was 100N/m, and the film 52 is dried for about 10 minutes until the amount of the remaining solvent becomes 0.3 mass %. Lap angles (center angles at which the film 52 comes in contact with the rollers 54) are 90 degrees and 180 degrees. The material of the roller 54 was aluminum or carbon steel, and a hard chrome coating was made on a surface. Two types of the rollers 54 were used. The first type is the roller 54 with a flat surface. The second type is the roller 54 with a blasted and mat processed surface. The positional fluctuations (or eccentricity) in the rotation of the roller 54 was 50 μm or less, and the bending of the roller 54 at the tension of 100N/m was 0.5 mm or less.

The solvent gas included in the drying chamber 15 is removed by using the adsorption recovery device 55. The adsorptive agent was activated carbon, and desorption was made with the dried nitrogen. Thus the moisture content of the recovered solvent was made 0.3 mass % or less, and thereafter the recovered solvent was used for the solvent for preparing the dope. The drying air includes not only the solvent gas but also other compounds such as the plasticizer, the UV-absorbing agent and the compounds of high boiling points. Therefore such compounds are removed by cooling of a cooling device and a preadsorber, and recycled. Then the adsorption and desorption conditions were set such that VOC (volatile organic compounds) in the outside exhaust gas is at 10 ppm or less. Further, the solvent amount recovered by the condensing method is 90 mass %, and most of the remainder is recovered by adsorption.

The dried film 52 is transported to a first humidification chamber (not shown). The drying air at 110° C. is supplied to the transfer section between the drying chamber 15 and the first humidification chamber. The air at 50° C., with the dew point of 20° C., is supplied to the first humidification chamber. Further, the film is transported to a second humidification chamber (not shown) which prevents occurrence of curling in the film 52. In the second humidification chamber, the air at 90° C. with the humidity of 70% is directly supplied to the film 52.

After humidification, the film 52 is cooled to 30° C. or below in a cooling chamber 16, and then both edge portions of the film 52 were trimmed. The compulsory neutralization device (the neutralization bar) 56 is provided to constantly keep the charged voltage from −3 kV to +3 kV while transporting the film 52. Further, knurling is provided on the both side edge portions of the film 52 by the knurling roller 57. Knurling is performed by embossing the film 52 from one side. The width of knurling is 10 mm, and the pressure is set such that the maximum height is 12 μm higher in average than the average thickness of the film 52.

Thereafter, the film 52 is transported to the winding chamber 17 in which the temperature was 28° C. and the humidity was 70%. Further, an ionizer (not shown) is disposed in the winding chamber 17 to keep the charged voltage in a range of −1.5 kV to +1.5 kV. Thus the film 52 (thickness of 40 μm) is obtained with the width of 1475 mm. The diameter of the winding shaft 58 was 169 mm. The tension was 300N/m in the beginning of winding and 200N/m in the end of winding. The total length of the wound-up film was 4000 m. In each side edge of the winding shaft 58, a part of the wound film may be projected or retracted from the side edge of the wound film in the width direction. Such displacement (which may be referred to as an oscillation range) is ±5 mm or less. The displacement of the film side edge at the winding shaft 58 during the winding may periodically occur in every 400 m. Further, a press roller 59 is pressed toward the winding roller 58 at 50N/m. In the winding, the temperature of the film 52 was 25° C., and the moisture content was 1.4 mass %, the content of the remaining solvent was 0.3 mass %. Average drying speed throughout the process was 20 mass % (dry measure)/min. Further, no winding looseness and wrinkles were found. Unevenness in winding did not occur in an impact test at 10G. An appearance of a roll was excellent.

A film roll of the film 52 was stored in a storing rack at 25° C. and 55% RH for a month, and the above test was carried out on the film 52. However, no significant differences were found. Further, there was no adherence between the films of the film roll. After the production of the film 52, residues of the casting film 39 were not found on the casting drum 31 after peeling off the casting film 39.

The unevenness in the thickness of the film 52 is measured by the following method and the following evaluations are made. The thickness is measured in five places of the film 52 at 25° C. and 60 RH % with the use of an electronic micrometer (produced by Anritsu). A relative standard deviation (RSD=deviation/average×100%) is calculated by the average and the deviation of the measured values. The unevenness in the film thickness is evaluated in 4 levels according to the calculated relative standard deviation value.

When the calculated value is less than 5%, the film is evaluated as (A) in which the uniformity in the film thickness is excellent.

When the calculated value is 5% or more but less than 10%, the film is evaluated as (B) in which the uniformity in the film thickness is good.

When the calculated value is 10% or more but less than 15%, the film is evaluated as (C) in which the unevenness in the film thickness is found, but the product is acceptable.

When the calculated value is 15% or more, the film is evaluated as (F) in which the unevenness in the film thickness is found and the product is not acceptable.

TABLE 1

| | | | Opening | | |
|---|---|---|---|---|---|
| | | | ratio (%) | | Uneven- |
| Experi- | | | of first air | | ness |
| ment | Decompression | Clearance | shielding | Distance | in film |
| No. | degree (Pa) | CL (mm) | plate | L (mm) | thickness |
| 1 | 300 | 0.5 | 20 | 40 | A |
| 2 | 300 | 0.5 | 20 | 20 | A |
| 3 | 300 | 0.5 | 15 | 40 | A |
| 4 | 300 | 0.5 | 10 | 40 | A |
| 5 | 500 | 0.5 | 15 | 40 | A |
| 6 | 500 | 0.3 | 15 | 80 | A |
| 7 | 300 | 0.7 | 20 | 40 | A |
| 8 | 300 | 0.5 | 25 | 40 | A |
| 9 | 300 | 0.5 | 20 | 80 | A |
| 10 | 300 | 0.5 | 20 | 100 | A |
| 11 | 500 | 0.5 | 15 | 80 | B |
| 12 | 300 | 0.7 | 15 | 80 | B |
| 13 | 300 | 3.2 | 15 | 40 | B |
| 14 | 300 | 0.5 | 3 | 40 | B |
| 15 | 300 | 0.5 | 35 | 40 | B |
| 16 | 300 | 0.5 | 15 | 10 | C |
| 17 | 300 | 0.5 | 15 | 120 | C |

| | | | |
|---|---|---|---|
| 18 | 300 | No air shielding plate | F |

In Table 1, according to the experiments 1 to 17 of the present invention, the unevenness in the film thickness is prevented by decompressing the upstream area from the casting bead (in a range of 300 Pa to 500 Pa below the atmospheric pressure) and providing the first air shielding plate 70 in the decompression chamber 70. Further, the unevenness in the film thickness is excellently prevented in experiments 1-10 which are evaluated as (A). In the experiments 1-10, the distance L (mm) between the contact position A of the casting bead and the first air shielding plate 70 is set in the range between 20 mm and 100 mm, and the relationship between the opening ratio of the first air shielding plate 70 and the distance L (mm) is optimized.

### Embodiment 2

The embodiment 2 is described in the following. However, the present invention is not limited to the embodiment 2. Note that the description is carried out in detail in the experiment 19. However, the description of the same experiment conditions as the experiment 1 is omitted. Further, regarding the experiments 20 to 27 according to the present invention and the comparison experiment 28, the experiment conditions and the results will be shown together in the Table 2 later.

Each pts. mass of the raw materials used in the experiment 19 is shown below.

[Composition]

| | | |
|---|---|---|
| Cellulose triacetate (degree of substitution is 2.83, | 28 | pts. mass |
| viscometric average degree of polymerization is 320, | | |
| moisture content is 0.4 mass %, viscosity of 6 mass % | | |
| of dichloromethane solution is 305 mPa · s) | | |
| Methyl Acetate | 75 | pts. mass |
| Cyclopentanone | 10 | pts. mass |
| Acetone | 5 | pts. mass |
| Methanol | 5 | pts. mass |
| Ethanol | 5 | pts. mass |
| Plasticizer A (Dipentaerythritol hexaacetate) | 1 | pts. mass |
| Plasticizer B (Triphenylphosphate) | 1 | pts. mass |
| Fine particles (silica with the particle diameter of | 0.1 | pts. mass |
| 20 nm) | | |
| UV agent a | | |
| (2,4-bis-(n-octylthio)-6-(4-hydroxy-3,5-di-tert- | 0.1 | pts. mass |
| butylanilino)-1,3,5-triazine | | |
| UV agent b | | |
| 2(2′-hydroxy-3′,5′-di-tert-butylphenyl)-5- | 0.1 | pts. mass |
| chlorobenzotriazol | | |
| UV agent c | | |
| 2(2′-hydroxy-3′,5′-di-tert-amylphenyl)-5- | 0.1 | pts. mass |
| chlorobenzotriazol | | |
| C₁₂H₂₅OCH₂CH₂O—P(═O)—(OK)₂ | 0.05 | pts. mass |

Note that the UV agents are the ultraviolet absorbing agents.

The experiment 19 is carried out in the same condition as the experiment 1 except that the dope is prepared in the above composition. Further, the evaluation is carried out in the same manner as the experiment 1.

TABLE 2

| | | | Opening | | |
|---|---|---|---|---|---|
| | | | ratio (%) | | Uneven- |
| Experi- | | | of first air | | ness |
| ment | Decompression | Clearance | shielding | Distance | in film |
| No. | degree (Pa) | CL (mm) | plate | L (mm) | thickness |
| 19 | 300 | 0.5 | 20 | 40 | A |
| 20 | 300 | 0.3 | 15 | 80 | A |
| 21 | 300 | 0.7 | 20 | 40 | A |
| 22 | 300 | 0.7 | 15 | 80 | B |
| 23 | 300 | 3.2 | 15 | 40 | B |
| 24 | 300 | 0.5 | 3 | 40 | B |
| 25 | 300 | 0.5 | 35 | 40 | B |
| 26 | 300 | 0.5 | 15 | 10 | C |
| 27 | 300 | 0.5 | 15 | 120 | C |

| | | | |
|---|---|---|---|
| 28 | 300 | No air shielding plate | F |

In Table 2, according to the experiments 19 to 27 of the present invention, the unevenness in the film thickness is prevented by decompressing the upstream area from the casting bead (in a range of 300 Pa to 500 Pa below the atmospheric pressure) and providing the first air shielding plate 70 in the decompression chamber 36. Further, as with the experiments 1 to 17 in the table 1, the unevenness in the film thickness is prevented by setting the distance L (mm) between the contact position A of the casting bead and the first air shielding plate 70 is set in the range between 20 mm and 100 mm.

Thus, the present invention is not restricted to the above embodiment, and various changes and modifications are possible in the present invention and may be understood to be within the present invention.

### INDUSTRIAL APPLICABILITY

The solution casting method of the present invention is applicable to the production of the film used as the protection film for the polarizing filter or the optical compensation film in the LCD device and the like, or the photographic support film.

1. A solution casting method comprising the steps of:
casting a dope including a polymer and a solvent from a casting die to a moving support to form a casting film;
decompressing an upstream area from a casting bead with respect to a moving direction of said support by a decompression device, said casting bead being formed of said dope from said casting die to said support, said decompression device having a plate member inside thereof, said plate member extending in a width direction of said casting bead in a standing posture;
peeling said casting film from said support as a film; and
drying said film.

2. A solution casting method according to claim 1, wherein when a distance between a contact position of said casting bead to said support and said plate member is defined as L (mm), L satisfies 20 mm≦L (mm)≦100 mm.

3. A solution casting method according to claim 1, wherein an opening is provided in said plate member to pass said air flow.

4. A solution casting method according to claim 3, wherein said openings are formed in an upper half portion of said plate member in a vertical direction.

5. A solution casting method according to claim 4, wherein an area ratio of said openings to said plate member is in a range of 0.5% to 30%.

6. A solution casting method according to claim 1, wherein a clearance CL (mm) between said decompression chamber and said support is in a range of 0.05 mm to 3.0 mm.

7. A solution casting method according to claim 1, wherein a pressure inside of said decompression chamber is set in a range of (atmospheric pressure—2000)Pa to (atmospheric pressure—10)Pa.

8. A solution casting method according to claim 1, wherein a moving speed of said support is in a range of 30 m/min to 150 m/min.
